(19) United States
(12) Patent Application Publication
(10) Pub. No.: US 2020/0175522 A1
(43) Pub. Date: Jun. 4, 2020

(54) PREDICTING ONLINE CUSTOMER SERVICE REQUESTS BASED ON CLICKSTREAM KEY PATTERNS

(71) Applicant: FMR LLC, Boston, MA (US)

(72) Inventors: Xiao Zhang, Norwood, MA (US); Vineel Gujjar, Cumberland, RI (US); James Brown, Brooklyn, NY (US); Shailesh Lahariya, Raleigh, NC (US); Scott Geller, Smithfield, RI (US)

(21) Appl. No.: 16/204,907

(22) Filed: Nov. 29, 2018

(51) Int. Cl. G06Q 30/00; G06F 7/16; G06Q 10/06

(52) U.S. Cl. CPC G06Q 30/016; G06Q 10/06393; G06F 7/16

(57) ABSTRACT

A method for determining a customer service metric using time-based predictive association based on user interactions over interaction channels. Events associated with intended transaction types are identified as characterized or uncharacterized, and sorted chronologically based on when the event occurred. Sequences of events are created based on analysis of each event against a chronologically consecutive later event and a determination of whether each event is uncharacterized and occurred before the later event and the sequence does not include a characterized event, or, that the earlier event is a characterized event or the sequence includes a characterized event, and the earlier event occurred a period of time before the later event. The later event is appended to a sequence, or an additional sequence is created including the later event, and the sequences are filtered. A customer service metric is determined based on a duration of time calculated for each sequence.

### TECHNICAL FIELD

This application relates to systems and methods for determining a customer service metric using time-based predictive association based on user interactions over a plurality of interaction channels and predicting a service request by a user based upon patterns of non-adjacent sequential items of clickstream data.

### BACKGROUND

A customer of a retail business may initiate and carry out a service request in order to add or update the customer's account information (e.g., change of address, addition of beneficiary, etc.). In many instances, the customer can reach out to the business via a variety of channels or interaction touch-points such as phone, email, postal mail, fax, online chat, website, branch visits, and others. Complex service requests often require a customer to use a mix of different channels in succession to complete the service request. For example, a service request for establishing trade authorization on the customer's brokerage account can involve the customer first researching the brokerage's website, subsequently calling a service representative on the phone, downloading the appropriate forms from the website, and finally, mailing completed forms to the brokerage via postal mail.

This type of multi-channel customer-journey-sequencing (e.g., a customer going from web-channel, to phone-channel, back to web-channel, then finally to the postal mail channel) can be a source of customer frustration, particularly when the customer's “journey” requires interactions over several channels and can be drawn out over a period of time due to unsuccessful attempts to reach completion.

Prior efforts to improve customer experience have sought to optimize the customer journey by reducing the number of channels utilized or the amount of time required to complete a particular service request. However, these efforts have been hampered by difficulties in accurately identifying and characterizing the customer journey for particular service requests due to incomplete information and disparate data types associated with the different channels. For example, each channel type requires a different process for capturing information related to service requests, and the information processing systems used by each channel type are often incompatible with one another and/or operated at disparate locations that are not network-connected.

### SUMMARY

There is therefore a need for effective systems and methods for determining a customer service metric using time-based predictive association based on user interactions over a plurality of interaction channels and predicting a service request by a user based upon patterns of non-adjacent sequential items of clickstream data.

The technology disclosed herein provides an automated and adaptive system and method for quantitatively characterizing journey entry points, and holistically assembling customer journey sequences given legacy systems that typically capture channel-specific incomplete data about customer's touch-points. This technology is useful for industries such as telecom, e-retail, Banking and Financial Services (“BFSI”), and entertainment where they try to understand their customer's pain-points and behaviors in their service offerings. However, the technology is not limited to any particular industry and is flexible enough to be used in any industry where customers are exposed to multi-channel environments, and the business is attempting to understand their customer's pain-points and behaviors in their service offerings:

In particular, the technology implements a highly-adaptive framework, and uses a configurable and modular framework to systematically build a cross-channel, cross-platform view of all users of a business or entity, and process many customer service interactions at scale, e.g. over 120 customer service interactions over any given duration (past 120 days, 90 days, 24 hours, etc.).

In some aspects, the technology features a method for determining a customer service metric using time-based predictive association based on user interactions over a plurality of interaction channels. A server computing device captures a plurality of events associated with one or more intended transaction types. The server computing device identifies each event of the plurality of events as a characterized event or an uncharacterized event. The server computing device sorts the plurality of events in chronological order based on an attribute of each event indicating a time at which the event occurred. The server computing device creates a sequence of events including the earliest event of the plurality of events. The server computing device processes the plurality of events in chronological order. Each event of the plurality of events is analyzed against a chronologically consecutive event that occurred later in time. The processing step includes the server computing device determining that the earlier event is an uncharacterized event that occurred within a first predetermined period of time before the later event, and the sequence does not comprise a characterized event, or that the earlier event is a characterized event or the sequence comprises a characterized event, and the earlier event occurred within a second predetermined period of time before the later event. The processing step also includes the server computing device appending the later event to the sequence of events, or creating an additional sequence of events comprising the later event. The server computing device repeats the processing step for one or more additional sequences of events until each event of the plurality of events is included in one of the sequences of events. The server computing device filters the sequence of events and any additional sequences of events. The server computing device determines a customer service metric based on a duration of time calculated for each sequence of events.

The above aspects can include one or more of the following features. In some embodiments, filtering the sequence of events and any additional sequences of events includes the server computing device discarding sequences of events that do not comprise a characterized event, and the server computing device determining that the sequences of events includes a characterized event indicative of the same intended transaction type, and an event in a first sequence of events occurred within a third predetermined period of time of an event in a second sequence of events, and the server computing device merging sequences of events.

In some embodiments, filtering the sequence of events and any additional sequences of events includes the server computing device determining a sequence retention threshold based on a frequency of occurrence for each of a plurality of historical sequences. The server computing device discards sequences of events matching one of the plurality of historical sequences whose frequency of occurrence is less than the sequence retention threshold, and the server computing device determines that the sequences of events includes a characterized event indicative of the same intended transaction type, and an event in a first sequence of events occurred within a third predetermined period of time of an event in a second sequence of events. The server computing device merges sequences of events.

In some embodiments, identifying each event of the plurality of events as a characterized event or an uncharacterized event includes, for each event, analyzing, by the server computing device, interaction channel data corresponding to a interaction channel utilized during an event, tagging, by the server computing device, the event as a characterized event if an intended transaction type can be determined based on interaction channel data associated with the event, and tagging, by the server computing device, the event as an uncharacterized event if an intended transaction type cannot be determined based on interaction channel data associated with the event.

In some embodiments, the interaction channel data includes one or more of tokens extracted from at least one URL clicked by the user, keywords entered in an internet search by the user, notes generated by a call center operator based on a call with the user, a transcript of an online chat session between a customer service agent and the user, and notes generated by a customer service representative based on a branch visit by the user. In some embodiments, the interaction channel utilized during an event comprises one of a phone, an email, a postal mailing, a fax, an online chat, a webpage, and a branch visit.

In some embodiments, the second predetermined period of time is longer in duration that the first predetermined period of time. In some embodiments, the third predetermined period of time is longer in duration that the second predetermined period of time. In some embodiments, each of the plurality of events is associated with a customer based on event data. In some embodiments, event data comprises one or more of a customer identification number, a customer account number, customer credential information, and a customer social security number.

In some embodiments, determining a customer service metric further includes

calculating, for each sequence of events, a duration of time from when its first event occurred until its last event occurred, and determining a customer service metric further includes computing an average duration of time to complete an intended transaction type based on the calculated durations of time for sequences of events comprising a characterized event indicative of the intended transaction type.

In some embodiments, the server computing device includes at least one of a cluster of server computing devices, a server computing device employing massively parallel computing algorithms, and a server computing device employing a plurality of processors. In some embodiments, the second predetermined period of time is determined based on an output of a machine learning model applied to a plurality of historical sequences. In some embodiments, the second predetermined period of time is determined based on an output of a machine learning model applied to the calculated durations of time.

In another aspect, the technology features a computerized method for predicting a service request by a user based upon patterns of non-adjacent sequential items of clickstream data. A server computing device captures clickstream data corresponding to web browsing activity of a user, the clickstream data comprising a plurality of items and a plurality of timestamps. The server computing device parses the clickstream data into one or more sessions comprising one or more of the plurality of items. A difference between timestamps of consecutive items in each of the one or more sessions is less than a first predetermined threshold of time. The server computing device determines a pattern for each item of the one or more sessions. Each pattern includes an item of a session and any subsequent items in the session that occurred within a second predetermined threshold of time. The server computing device generates a feature vector based upon a frequency of each pattern. The server computing device defines a set of key patterns based upon the feature vector. The server computing device predicts a service request by the user based upon the occurrence of one or more of the key patterns.

In some embodiments, generating the feature vector further includes the server computing device generating a frequency matrix comprising for each session a frequency value indicating a number of times each pattern occurred in the session, and generating the feature vector based upon the frequency matrix, the feature vector comprising for each pattern a value indicating a sum of the frequency values for each pattern for all of the one or more sessions.

In some embodiments, defining the set of key patterns further includes the server computing device determining, based on the feature vector, patterns with frequency values within a predetermined frequency range, and appending the patterns with frequency values within a predetermined frequency range to the set of key patterns. In some embodiments, each of the plurality of items represents a web link clicked by the user.

In some embodiments, each of the plurality of timestamps corresponds to one of the plurality of items and indicates a time the web link represented by the corresponding item was clicked. In some embodiments, the first predetermined threshold of time is smaller than the second predetermined threshold of time. In some embodiments, the first predetermined threshold of time is larger than the second predetermined threshold of time.

In some embodiments, predicting the service request by the user further includes the server computing device capturing service request data including a plurality of service requests and a plurality of service timestamps indicating a time each service was requested, and correlating one or more of the key patterns with each service request based upon the proximity in time between the occurrence of the one or more key patterns with the service request.

In some embodiments, the proximity in time between the occurrence of the one or more key patterns with the service request is about a minute. In some embodiments, the server computing device includes a parallelized cluster of computing nodes. In some embodiments, the server computing device includes at least one of: a cluster of server computing devices, a server computing device employing massively parallel computing algorithms, and a server computing device employing a plurality of processors.

In some embodiments, determining the second predetermined threshold of time is based on an output of a machine learning model applied to a plurality of historical items and a plurality of historical timestamps.

### BRIEF DESCRIPTION OF THE DRAWINGS

The advantages of the systems and methods described herein, together with further advantages, may be better understood by referring to the following description taken in conjunction with the accompanying drawings. The drawings are not necessarily to scale, emphasis instead generally being placed upon illustrating the principles of the described embodiments by way of example only.

FIG. 1 is a block diagram of a computing environment for multi-channel measurement and tracking of customer service requests according to embodiments of the technology described herein.

FIG. 2a-FIG. 2g show block diagrams of a variety of channels according to embodiments of the technology described herein.

FIG. 3 is a diagram showing a visualization of an exemplary journey sequence according to embodiments of the technology described herein.

FIG. 4 is a table showing backend data corresponding to the journey sequence shown in FIG. 3.

FIG. 5 is a diagram showing a visualization of an exemplary journey sequence at three stages during filtering operations according to embodiments of the technology described herein.

FIG. 6 is a diagram showing a visualization of an exemplary journey sequence at three stages during filtering and merging operations according to embodiments of the technology described herein.

FIG. 7 is a flow diagram of a computer-implemented method for determining a customer service metric using time-based predictive association based on user interactions over a plurality of interaction channels according to embodiments of the technology described herein.

FIG. 8 is a flow diagram of a computerized method for predicting a service request by a client based upon patterns of non-adjacent sequential items of clickstream data according to embodiments of the technology described herein

### DETAILED DESCRIPTION

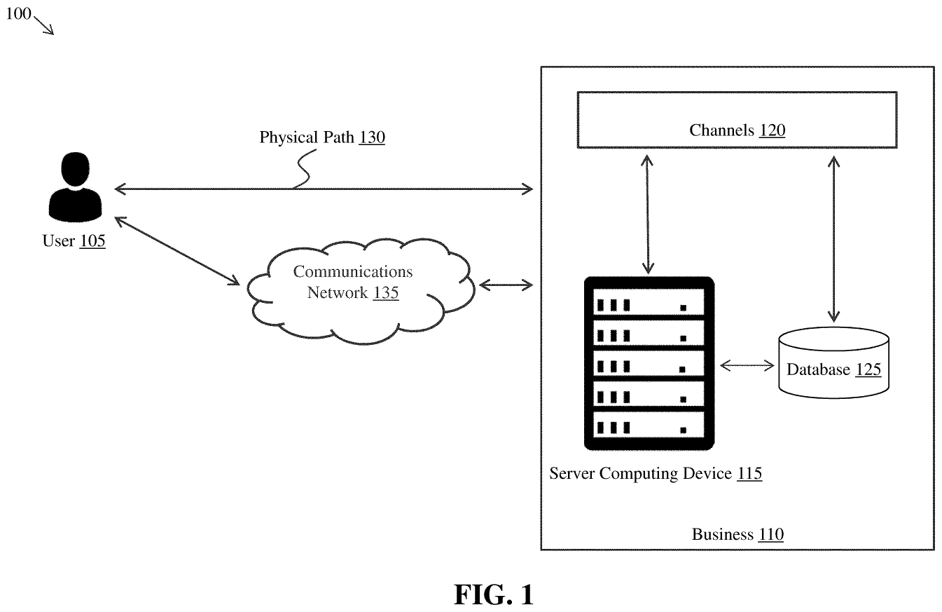

FIG. 1 is a block diagram of an exemplary computing environment 100 for multi-channel measurement and tracking of customer service requests. Computing environment 100 includes user 105, business 110, physical path 130, and communications network 135.

User 105 is a customer having some form of an account with business 110. Business 110 is a business entity in a particular industry (e.g., telecom, e-retail, Banking and Financial Services (“BFSI”), entertainment, etc.). However, business 110 is not limited to being in any particular industry. For example, business 110 can be any entity having users or account holders that connect to business 110 for carrying out a service request relating to the operations of the entity. In some embodiments business 110 is an educational institution.

Business 110 includes various facilities and IT infrastructure for conducting its retail and internal business operations. For example, as shown in FIG. 1, business 110 can include server computing device 115 (hereinafter “server 115”), channels 120, and database 125. Server 115, channels 120, and database 125 operate in tandem to implement the logic operations in accordance with the embodiments of the technology described herein. Although only a single server 115 and database 125 are shown, it should be understood that server 115 and database 125 can include a plurality of server computing devices and databases, and can support connections to a variety of communications media types and protocols. Further, business 110 can include multiple buildings or facilities, each having computing infrastructure for implementing some or all of the methods described herein. The methods implemented by this technology may be achieved by implementing program procedures, modules and/or software executed on, for example, a processor-based computing device or network of computing devices.

Server 115 is a computing device (or in some embodiments, a set or cluster of computing devices) that comprises a combination of hardware, including one or more processors and one or more physical memory modules, and specialized software engines and models that execute on the processor of server 115, to receive data from other components shown in computing environment 100, transmit data to other components of computing environment 100, and perform the functions described herein. In some embodiments, server 115 includes one or more of a cluster of server computing devices, a server computing device employing massively parallel computing algorithms, and a server computing device employing a plurality of processors.

In some embodiments, server 115 includes specialized sets of computer software instructions programmed onto a dedicated processor in the server 115 and can include specifically-designated memory locations and/or registers for executing the specialized computer software instructions. Although server 115, database 125 and channels 120 are depicted as being collocated in FIG. 1, in some embodiments the functionality of these components can be distributed among a plurality of server computing devices located at multiple physical locations. It should be appreciated that any number of computing devices, arranged in a variety of architectures, resources, and configurations (e.g., cluster computing, virtual computing, cloud computing) can be used without departing from the scope of the invention. The exemplary functionality of the technology is described in detail below.

Database 125 is a computing device (or in some embodiments, a set of computing devices) that is in communication with server 115 and channels 120, and is configured to receive, generate, and store specific segments of data relating to the operations described herein. For example, database 125 can store data related to its customers or users, such as user account information and preferences, and can also store data that is used to host services offered by business 110, such as data that is used to populate UIs for web-hosted tools. In some embodiments, all or a portion of the database 125 can be integrated with the server 115 or be located on a separate computing device or devices. For example, the database 125 can comprise one or more databases, such as MySQL™ available from Oracle Corp. of Redwood City, Calif.

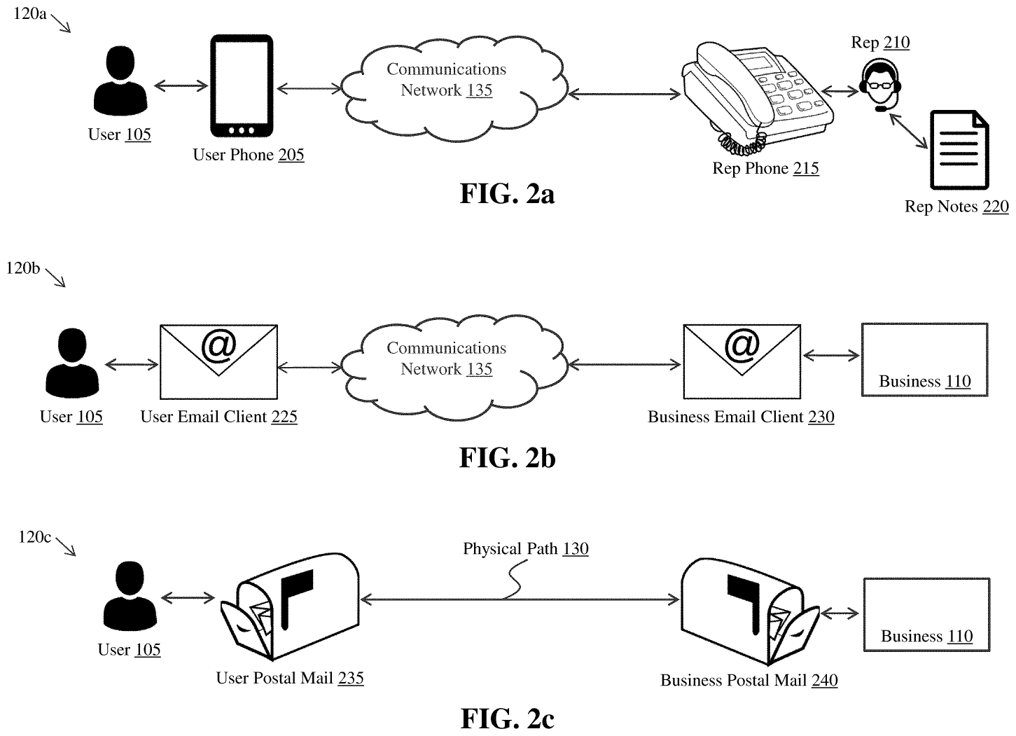

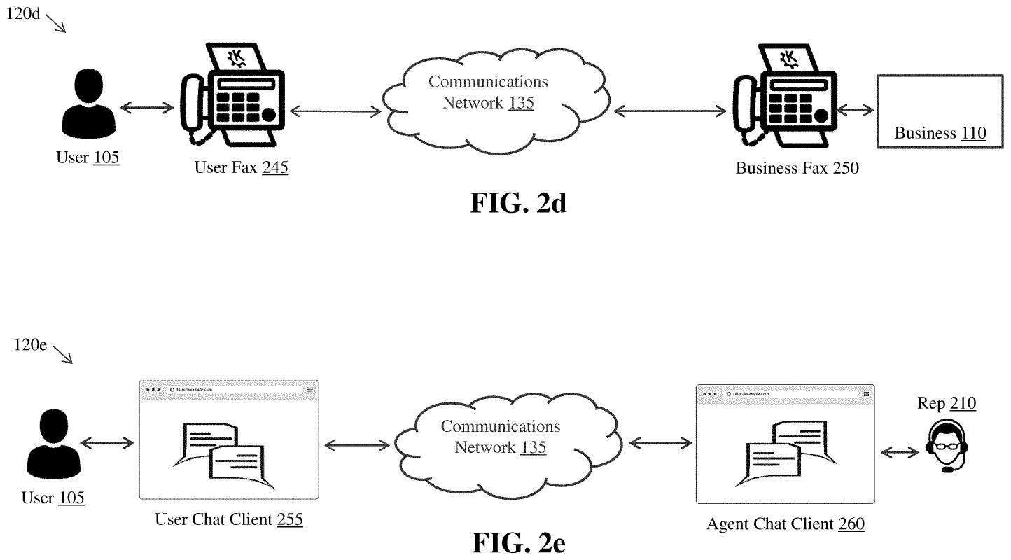

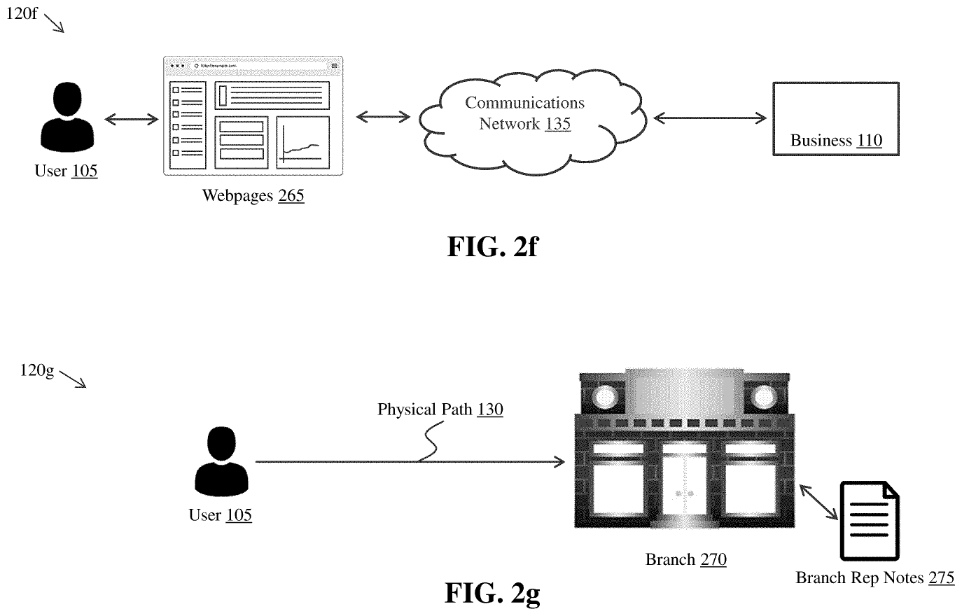

Channels 120 include hardware and software resources for implementing a variety of communication and data channels or “touch-points” for a user to interact with business 110 to carry out a service request. Channels 120 can be configured to provide facilities for the user to interact with business 110 over several disparate mediums and devices such as phone, email, postal mail, fax, online chat, website, branch visits, and others. Channels 120 are described in more detail below in connection with FIG. 2a-FIG. 2g.

Communications network 135 can be a local network, such as a LAN, or a wide area network (“WAN”), such as the Internet and/or a cellular network. Communications network 135 can further comprise components of both a LAN and a WAN, or any other type of network known in the art. Communications network 135 facilitates communications between user 105 and the digital network and telephony-based channels 120 of business 110 that user 105 may use to carry out service requests with business 110. For example, user 105 can connect to particular channels 120 of business 110 over communications network 135 using a device (e.g., mobile device, cellular phone, personal digital assistant device, smart phone, tablet, desktop computer, or laptop computer) having network-interface components to enable connectivity to communications network 135 via multiple mediums and network types. The network-interface components can include components to connect to either of a wired network or a wireless network, such as a Wi-Fi or cellular network, in order to access a wider network, such as the Internet.

Physical path 130 can include various non-network connections and touch-points between user 105 and business 110. For example, physical path 130 can include letter and package delivery services such as those provided by the United States Postal Service and other carriers. In some embodiments, physical path 130 includes the infrastructure and transportation services used by user 105 to visit a branch location of business 110.

FIG. 2a-FIG. 2g show block diagrams of a variety of channels or interaction points that user 105 can use for carrying out service requests with business 110.

FIG. 2a is a block diagram of phone channel 120a. User 105 can place a call to business 110 on user phone 205 over communications network 135. A rep 210 employed by business 110 can field and conduct the incoming call on rep phone 215 to assist user 105 in carrying out the desired service request.

In some embodiments, user phone 205 and rep phone 215 can each be one of a smartphones, tablet computer, and other mobile computing devices known in the art. In some embodiments, one or both of user phone 205 and rep phone 215 can be a laptop or desktop computer equipped with hardware and software for making phone calls using Voice over Internet Protocol (“VoIP”).

In some embodiments, rep 210 logs certain information about the call in rep notes 220. For example, rep 210 can capture notes on the purpose of user 105's call, instructions rep 210 gave to user 105, and data about the call such as date, time and duration. In some embodiments, rep notes 220 is a document file associated with user 105. In some embodiments, rep notes 220 is a field-based user interface and rep 210 enters notes by populating the fields of the user interface with data that is added to user 105's account information.

In some embodiments, rep phone 215 is a call center phone system that prompts user 105 to provide certain information via voice or button presses prior to being connected to rep 210. For example, user 105 can be prompted to provide certain account information and the reason for the call in order to route user 105 to a rep that is best qualified to assist user 105. In some embodiments, rep phone 215 is configured to populate call log 222 with certain data about the call such as reason for the call, date, time and duration. In some embodiments, call log 222 is a document file associated with user 105.

FIG. 2b is a block diagram of email channel 120b. Using a user email client 225 installed on a network-connected computing device, user 105 can draft and send email related to a desired service request to business 110 over communications network 135. Business 110 receives the email from user 105 via business email client 230. In some embodiments, a rep employed by business 110 reviews the email and sends a response with the requested information or instructions back to user 105 using business email client 230. In some embodiments, artificial intelligence techniques are employed to determine the subject matter of the email from user 105 in order to route it to a rep of business 110 that is best qualified to assist user 105 with the service request.

In some embodiments, the rep that handles the email from user 105 logs certain information about the subject matter of the email and any subsequent email exchanges to a file associated with user 105. In some embodiments, artificial intelligence techniques are used to ascertain and log information about the subject matter of the email from user 105 to a file associated with user 105.

FIG. 2c is a block diagram of postal mail channel 120c. As discussed above, postal mail can be sent between two parties via physical path 130. User postal mail 235 is a residential mailbox owned by user 105, a post office box rented by user 105, or a mailbox or mail stop that user 105 otherwise has the use of. Business postal mail 240 is a mailbox or facility that business 110 uses for its mail.

In some embodiments, user 105 mails certain forms or documents required to complete a service request to business 110 via postal mail channel 120c. For example, user 105 can mail executed forms such as a power of attorney or a trade authorization to business 110 via postal mail channel 120c. In some embodiments, information about the subject matter of the mail from user 105 is logged to user 105's account when mail is processed at business 110.

FIG. 2d is a block diagram of fax channel 120d. User fax 245 can be used by user 105 to send and receive fax transmissions related to a desired service request to and from business 110 over communications network 135. Business 110 receives the fax transmission from user 105 via business fax 250. In some embodiments, a rep employed by business 110 reviews the fax transmission and sends a response with the requested information or instructions back to user 105 using business fax 250. In some embodiments, the rep uses a different one of the channels 120 to communicate with user 105 upon receipt of the fax transmission. In some embodiments, the rep updates a document file associated with user 105 based on the subject matter of the fax transmission. As one example, if user 105 transmits an executed power of attorney to business 110 via fax channel 120d, the rep can make a note of it in user 105's account information.

FIG. 2e is a block diagram of chat channel 120e. Using a user chat client 255 installed on a network-connected computing device, user 105 can initiate and conduct a chat session with business 110 over communications network 135. At business 110, rep 210 uses agent chat client 260 to receive and respond to instant messages from user 105. In some embodiments, one or both of user chat client 255 and agent chat client 260 are a separate piece of software installed on computing device. In some embodiments, one or both of user chat client 255 and agent chat client 260 are browser-based clients.

In some embodiments, a bot or other artificial intelligence techniques are employed to initially determine the subject matter of user 105's request in order to route it to a rep of business 110 that is best qualified to assist user 105 with the service request. In some embodiments, the chat session is logged and artificial intelligence techniques are employed to add notes to user 105's account information related to the nature of the service request. In some embodiments, rep 210 logs certain information about the subject matter of the chat session to a file associated with user 105.

FIG. 2f is a block diagram of web channel 120f. Using a web browser installed on a network-connected computing device, user 105 can visit webpages 265 over communications network 135 to conduct research about a particular service request, or to initiate and carry out a service request using web-fillable forms provided by business 110. In some embodiments, webpages 265 are hosted from server computing devices at business 110. In some embodiments, webpages 265 are hosted from an Internet service provider or cloud computing services provider contracted by business 110.

Web channel 120f can provide useful information about the intended service request user 105 is trying to initiate or carry out. For example, putting aside errant or transient clicks, if user 105 clicks a link labeled “Change Beneficiary Information,” it can be reliably determined that the service request user 105 is attempting to initiate involves change to the beneficiary information on an account of user 105.

Accordingly, business 110 logs certain information about the links clicked by user 105. For example, the web address of each clicked link can be logged, along with the date and time user 105 clicked each link, and the duration user 105 spent on each page. Using this data, a clickstream can be assembled detailing user 105's clicked path through webpages 265 during a particular session on web channel 120f.

In some embodiments, business 110 logs keywords entered by user 105 into a search bar or search function of webpages 265. Artificial intelligence techniques can be applied to the logged keywords to determine the nature of the service request user 105 was trying to initiate.

FIG. 2g is a block diagram of branch channel 120g. As discussed above, user 105 can visit a branch location (e.g., branch 270) of business 110 via physical path 130. At branch 270, user 105 can meet with a branch rep of business 110 to discuss and initiate a desired service request.

In some embodiments, the branch rep that worked with user 105 at branch 270 logs certain information about the interaction in branch rep notes 275. For example, the branch rep can capture notes on the purpose of user 105's visit, instructions the branch rep gave to user 105, and data about the visit such as date, time and duration. In some embodiments, branch rep notes 275 is a document file associated with user 105. In some embodiments, branch rep notes 275 is a field-based user interface and the branch rep enters notes by populating the fields of the user interface with data that is added to user 105's account information.

By analyzing and sequencing the information captured by each of the channels 120, business 110 can assemble a customer journey indicating each of the channels 120 utilized by user 105 while carrying out a service request or Stock Keeping Unit (hereinafter “SKU”). As used herein a SKU is defined as a unit of service that user 105 can request. For example, a service request to change the address associated with user 105's account at business 110 can be defined as a SKU.

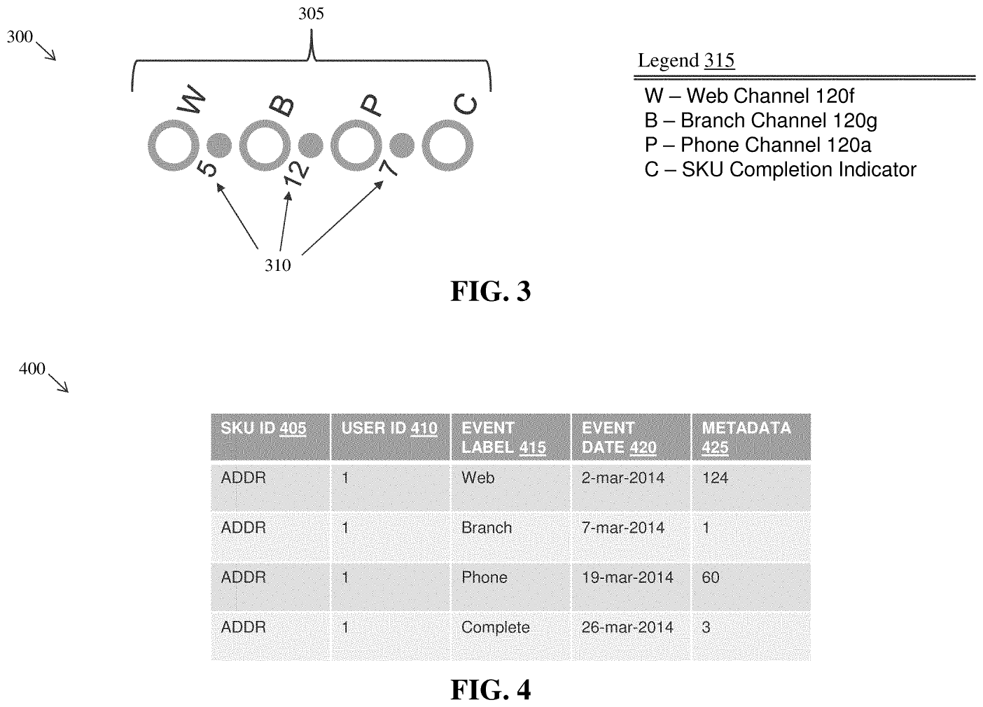

FIG. 3 is a diagram 300 showing a visualization of an exemplary journey sequence 305. Journey sequence 305 represents the user journey, namely all of the interactions of a single user with channels 120 of business 110 from initiation to completion of one SKU. In FIG. 3, each larger, unfilled circle represents an event in time, such as user 105 visiting branch 270, denoted by a capital letter “B” next to the second unfilled circle from the left. Legend 315 provides a key for identifying each event of channel interaction in journey sequence 305. Namely, “W” indicates an interaction with web channel 120f, “B” indicates an interaction with branch channel 120g, “P” indicates an interaction with phone channel 120a, and “C” indicates completion of the SKU. The events are arranged chronologically from left to right with the earliest event on the far left and completion of the SKU on the far right.

The amount of time that passed between adjacent events in journey sequence 305 is indicated by a solid dot labeled with a numeric duration 310 indicating a duration of time (e.g., seconds, minutes, hours, days, weeks, etc.). In the example of FIG. 3, duration 310 indicates a number of days, and journey sequence 305 depicts a journey where user 105 first visited webpages 265, then branch 270 after 5 more days, followed by a phone call 12 after that before finally completing the SKU successfully 7 days after the phone call.

FIG. 4 is a table 400 showing backend data corresponding to the visualization of journey sequence 305. Table 400 includes a row for each interaction user 105 had with one of the channels 120, and one denoting the completion of the SKU. The five columns of table 400 include data captured or determined during each interaction with one of the channels 120, and data about the completion of the SKU. Table 400 can be thought of as the table schema for the visualization of journey sequence 305.

Referring to the columns of table 400, SKU ID 405 contains a short form name or code identifying the particular SKU that was carried out by user 105 during the journey depicted by journey sequence 305. In this example, the SKU ID for a change of address SKU is “ADDR.” User ID 410 includes a unique identifier for user 105. In some embodiments, User ID 410 is populated with an account number of user 105. The entry in the event label 415 field of each row identifies which of the channels 120 was used by user 105 for a particular event, or that the event corresponds to the completion of the SKU. Event date 420 includes the date of each event. Event date 420 can also include time information indicating a number of minutes or hours user 105 used a particular one of channels 120. Metadata 425 holds event-specific metadata that can be used later for calculating Level of Effort (“LoE”) metrics.

According to embodiments of the technology described herein, assembly of a journey sequence such as journey sequence 305 begins with selection of a data collection period specifying the period of time for which data from channels 120 is to be collected. For example, the data collection period can define start and end dates, and data from channels 120 collected between those dates is grouped and analyzed. In some embodiments, a subset of channels 120 can be selected from which to collect and analyze data collected during the data collection period.

The data collected during the data collection period from interactions with each of the channels 120 is first analyzed to determine if the interaction can be attributed to a particular SKU. The logic for attributing the interaction or event to a SKU is channel-specific based on differences in the reliability of the data collected from each of the channels 120. For example, as discussed above, data collected from interactions with web channel 120f can reliably be attributed to the particular SKU user 105 is attempting to complete, as user 105 affirmatively clicks the URLs corresponding to the desired SKU (e.g., Change of Address, Change Beneficiary Information, etc.).

However, some of channels 120 have incomplete and noisy information capture systems. For example, phone call records from interactions with phone channel 120a typically contain information identifying the user that called and when, but they often do not capture the topic of conversation, in particular, the service request or SKU that was inquired about. Even when this information is captured, it is noisy, error-prone, and requires either in-situ, manual tagging (interaction flagging, e.g. “called about password reset”) by rep 210. Accordingly, for phone channel 120a and other of channels 120 with incomplete and noisy data (branch channel 120g, etc.), if the captured data about an event is not reliable enough to attribute the event with a particular SKU, all events for that channel are included.

In addition to data from channels 120, completion of a SKU is treated as an additional channel, and data specific to the completion event is collected for all completions that occurred during the data collection period.

Once the channel-specific data collected during the data collection period has been analyzed to determine if it is attributable to a particular SKU, the next step in assembling a user journey involves stacking all the channel-specific datasets into a single dataset by appending the data end-to-end into a single schema. The result of this operation is a plurality of journey sequences, each including data about a series events undertaken by a particular user in connection with a specific SKU. However, in this state many of the journey sequences erroneously include events not related to a specific SKU due to the considerations discussed above in connection with the data collected from channels such as phone channel 120a.

Events such as those related to interactions with web channel 120f that can be clearly attributed to a SKU by matching against known web URLs are referred to as anchor events. Conversely, those events that cannot be attributed to the SKU for which a journey sequence is being assembled are referred to as non-anchor events.

The technology described herein provides a methodology for filtering out the non-anchor events that are not relevant or related to the SKU. According to one aspect, the events of a journey sequence are processed chronologically starting from the earliest event in the journey sequence, and non-anchor events that occur in close proximity to anchor events are retained in the journey sequence, while other non-anchor events are filtered out. The notion of close proximity is determined and encoded based on three threshold values: non-anchor threshold, anchor threshold, and merging threshold.

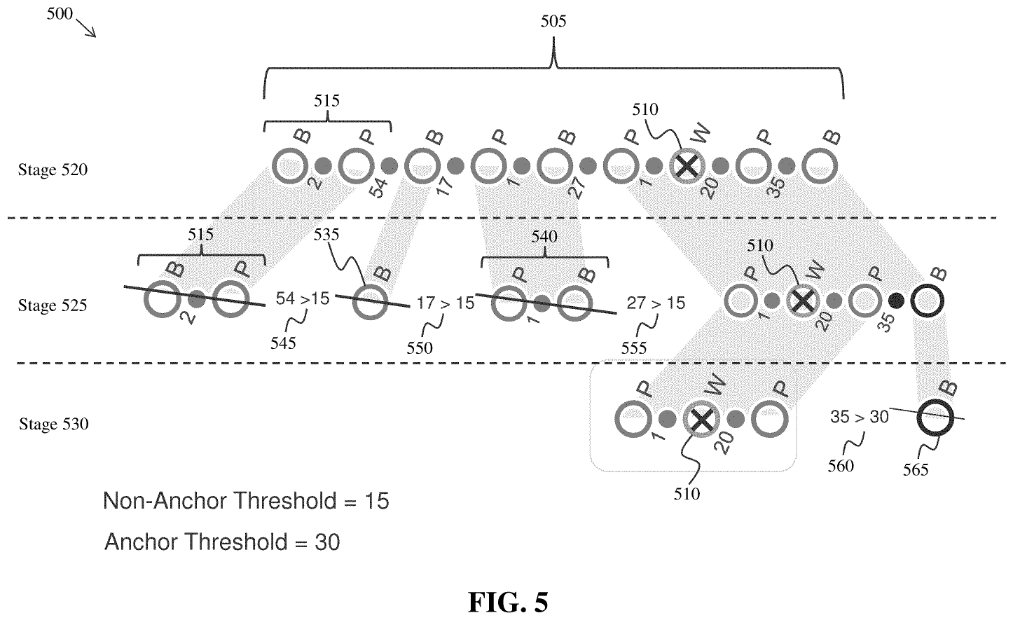

FIG. 5 is a diagram 500 showing a visualization of an exemplary journey sequence 505 at three stages during filtering operations, each stage separated by a dotted line. At stage 520, journey sequence 505 includes a single anchor event 510 from an interaction with web channel 120f, and eight non-anchor events resulting from interactions with phone channel 120a and branch channel 120g.

In this example, the first two non-anchor events, events 515, occur 54 days or more before the next event in journey sequence 505. Accordingly, it can reasonably be concluded that events 515 are long enough removed in time from other events in journey sequence 505 that they are not related to the relevant SKU and should therefore be filtered out of journey sequence 505. In some embodiments, one aspect of the filtering operations is based on a non-anchor threshold value indicating the maximum length of time that can occur between two adjacent non-anchor events in a journey sequence. In some embodiments, the non-anchor threshold value is based on an analysis of prior journey sequences for the same SKU.

Filtering operations continue to process adjacent non-anchor events of journey sequence 505 chronologically based on the non-anchor threshold. However, once an anchor event such as anchor event 510 is encountered, subsequent filtering operations are then based on an anchor threshold that is longer in duration than the non-anchor threshold. In some embodiments, the anchor threshold value indicates the maximum length of time that can occur between any two adjacent events in a journey sequence after an anchor event is encountered. In some embodiments, the filtering operations are again based on the non-anchor threshold after a certain number of non-anchor events are processed subsequent to encountering an anchor event.

In the example shown in FIG. 5, the non-anchor threshold is set to 15 days, and the anchor threshold is set to 30 days. Stage 525 shows the results of filtering operations prior to encountering anchor event 510. The two adjacent non-anchor events of events 515 occur within 2 days of each other. However, as denoted by comparison 545, the interaction with phone channel 120a of events 515 occurs 54 days prior to event 535, a non-anchor event based on an interaction with branch channel 120g. Accordingly events 515 are filtered out of journey sequence 505, denoted by a line through those events.

Further, as denoted by comparison 550, non-anchor event 535 occurs 17 days prior to the next chronologically adjacent event, the phone channel 120a interaction of events 540. Accordingly, event 535 is filtered out of journey sequence 505, denoted by a line through that event. Finally, as denoted by comparison 555, the interaction with branch channel 120g of events 540 occurs 27 days prior to the next chronologically adjacent non-anchor event, an interaction with phone channel 120a. Accordingly, events 540 are filtered out of journey sequence 505.

Stage 530 shows the results of filtering operations subsequent to encountering anchor event 510 when filtering operations are then based on an anchor threshold of 30 days between events. As denoted by comparison 560, the phone channel 120a interaction of events 540 occurs 35 days prior to event 565, a non-anchor event based on an interaction with branch channel 120g. Accordingly, event 565 is filtered out of journey sequence 505.

After filtering operations have completed, the filtering logic using the anchor-threshold and non-anchor threshold can result in journey sequences where two neighboring sequences close in time each include an anchor event. Assembly of the journey sequence then proceeds to a merging operation.

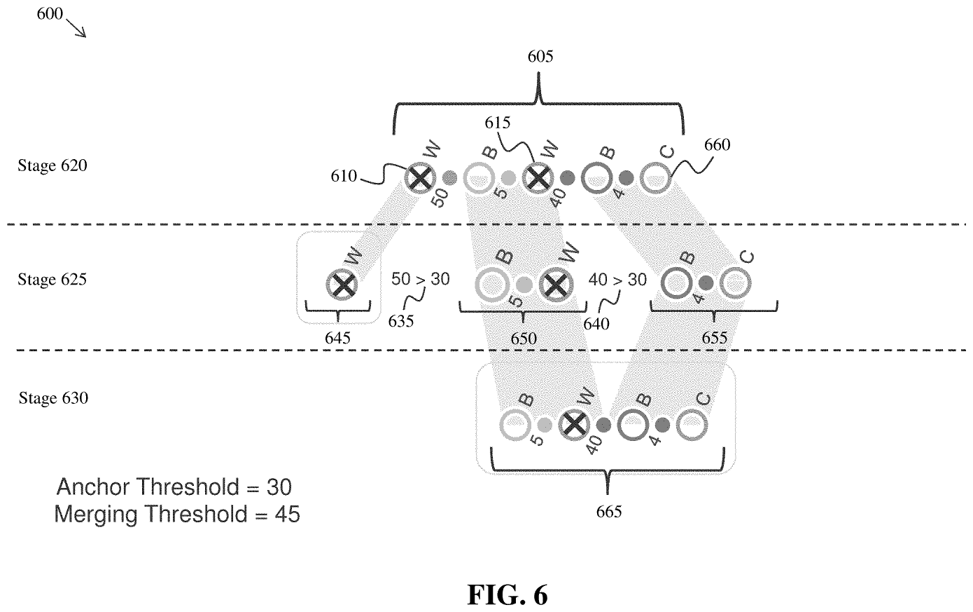

FIG. 6 is a diagram 600 showing a visualization of an exemplary journey sequence 605 at three stages including filtering and merging operations. The stages are separated by a dotted line. At stage 620, journey sequence 605 includes two anchor events, anchor event 610, anchor event 615, from interactions with web channel 120f, two non-anchor events resulting from interactions with branch channel 120g, and a completion event 660. For the purposes of the merging operations described herein, completion event 660 can be considered an anchor event because it can be reliably attributed to a SKU.

In the example shown in FIG. 6, the non-anchor threshold is set to 30 days. Stage 625 shows the results of the filtering operations. As shown, anchor event 610 occurs prior to the adjacent non-anchor event in journey sequence 605 by 50 days which exceeds the anchor threshold, as denoted by comparison 635. Therefore, anchor event 610 is not included in the journey sequence being assembled from the subsequent events.

Further, anchor event 615 occurs prior to the adjacent non-anchor event in journey sequence 605 by 40 days which also exceeds the anchor threshold, as denoted by comparison 640. Therefore, anchor event 615 and its associated non-anchor event are not included in the journey sequence being assembled from the subsequent events.

After filtering operations have completed, the filtering logic's use of the anchor and non-anchor thresholds can result in sub-sequences where two neighboring sequences in time each include an anchor event. For example, the filtering operations at stage 625 result in three separate sub-sequences: sub-sequence 645, sub-sequence 650, and sub-sequence 655, each of which include either an anchor event, or a completion event which can be treated as an anchor event for the purposes of the merging operations. In such cases, merging operations can be used to merge certain sub-sequences back together based on a merging threshold.

In the example shown in FIG. 6, the merging threshold is set to 40 days. Referring to stage 625, anchor event 610 of sub-sequence 645 occurs prior to the adjacent non-anchor event in sub-sequence 650 by 50 days which exceeds the merging threshold of 45 days. Therefore, sub-sequence 650 is not merged into the journey sequence being assembled.

However, anchor event 615 of sub-sequence 650 occurs prior to the adjacent non-anchor event in sub-sequence 655 by 40 days which is less than the merging threshold. Accordingly, as shown at stage 630, sub-sequence 650 and sub-sequence 655 are merged to form journey sequence 665.

Analysis of the user journey sequences assembled by operations of the described technology provides valuable insights into pain points experienced by users of the service infrastructure of a business, and can provide a measure of the effectiveness of the different interaction channels as used to carry out each type of service request. This is useful to identify deficiencies in the service offered by a business. The journey sequences also provide insight into the behavioral tendencies of users, such as an indication of their preferred interaction channels. In some embodiments, the journey sequences are used to generate a Level of Effort (“LoE”) metric for each type of service request.

In some embodiments, the journey sequences assembled by the technology described herein can be used to identify and correct issues with a particular channel or the required process for a service request.

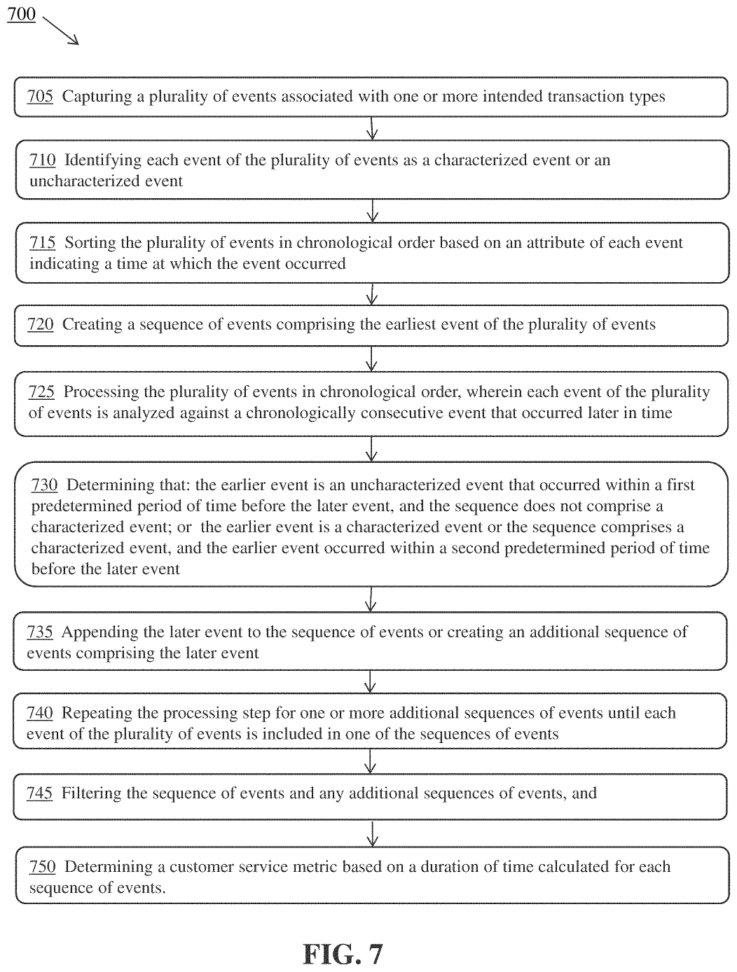

FIG. 7 is a flow diagram of a computer-implemented method 700 for multi-channel measurement and tracking of service requests. In particular, FIG. 7 shows a computer-implemented method for determining a customer service metric using time-based predictive association based on user interactions over a plurality of interaction channels. The server computing device captures (705) a plurality of events associated with one or more intended transaction types. As described above, server 115 can capture various information data about each interaction of user 105 has with any of channels 120 over the course of initiating and carrying out a particular service request.

The server computing device identifies (710) each event of the plurality of events as a characterized event or an uncharacterized event. For example, based on the channel type and the data captured in connection with user 105's interaction, channel server 115 characterizes each interaction event as an anchor event or a non-anchor event. In some embodiments, for each interaction user 105 has with one of channels 120, server 115 analyzes the interaction channel data corresponding to an interaction channel utilized during a particular event, and tags the event as an anchor event if a SKU can be determined based on interaction channel data associated with the event. Server 115 tags the event as a non-anchor event if a SKU cannot be determined based on interaction channel data associated with the event. In some embodiments, the interaction data analyzed by server 115 includes one or more of tokens extracted from at least one URL clicked by user 105, keywords entered in an internet search by user 105, notes generated by a call center operator based on a call with user 105, a transcript of an online chat session between a customer service agent and user 105, and notes generated by a customer service representative based on a branch visit by user 105. In some embodiments, the event data includes one or more of a user identification number, a user account number, user credential information, and a user social security number.

The server computing device sorts (715) the plurality of events in chronological order based on an attribute of each event indicating a time at which the event occurred. For example, server 115 can arrange the events chronologically based on data associated with the event indicating the date and time of user 105's interaction. The server computing device creates (720) a sequence of events comprising the earliest event of the plurality of events. Server 115 begins assembling a journey sequence by adding the earliest event captured during the data collection period.

The server computing device processes (725) the plurality of events in chronological order, and each event of the plurality of events is analyzed against a chronologically consecutive event that occurred later in time. As described above, server 115 processes the events of a journey sequence chronologically starting from the earliest event in the journey sequence.

The server computing device determines (730) that (i) the earlier event is an uncharacterized event that occurred within a first predetermined period of time before the later event, and the sequence does not comprise a characterized event, or (ii) the earlier event is a characterized event or the sequence comprises a characterized event, and the earlier event occurred within a second predetermined period of time before the later event. The server computing device appends (735) the later event to the sequence of events or creates an additional sequence of events comprising the later event.

According to filtering operations described in more detail above, before an anchor event is encountered, server 115 uses a non-anchor threshold to determine whether to include a non-anchor event in the journey sequence being assembled. Once an anchor event is encountered, server 115 uses an anchor threshold to determine whether to include a non-anchor event in the journey sequence being assembled. Further, if the time between the earlier and later events being analyzed exceeds the relevant threshold, server 115 stops appending events to the current sequence and begins assembling an additional sequence with the later event being the first event included in the additional sequence. In some embodiments, server 115 determines the anchor threshold based on an output of a machine learning model applied to a plurality of historical journey sequences, discussed below.

The server computing device repeats (740) the processing step for one or more additional sequences of events until each event of the plurality of events is included in one of the sequences of events. The server computing device filters (745) the sequence of events and any additional sequences of events. As described above, server 115 processes every event associated with a particular service request or SKU that occurred during the data collection period, and assembles journey sequences based on filtering operations.

In some embodiments, server 115 filters the journey sequences and any additional journey sequences by discarding sequences of events that do not comprise an anchor event, and determining the journey sequences include an anchor event indicative of the same SKU, and that an event in a first journey sequence occurred within a third predetermined period of time (e.g. merging threshold) of an event in a second journey sequence. The server 115 can then merge the journey sequences according to techniques described herein.

In some embodiments, server 115 filters the journey sequences and any additional journey sequences by determining a journey sequence retention threshold that is based on a frequency of occurrence for each of a plurality of historical sequences. For example, each time a journey sequence is assembled for a particular SKU, it can be stored in a database (e.g., database 125) accessible by server 115. Server 115 can analyze the data about each journey sequence to identify certain journey sequences of events that occur over and over for a particular SKU. Based on this data about the frequency with which a particular journey sequence occurs, a journey sequence retention threshold can be set for each recurring journey sequence.

As server 115 filters each journey sequence, it discards any sequences of events that match one of the plurality of historical sequences having a frequency of occurrence that is less than the corresponding sequence retention threshold. Server 115 can determine the journey sequences include an anchor event indicative of the same SKU, and that an event in a first journey sequence occurred within a third predetermined period of time of an event in a second journey sequence. The server 115 can then merge the journey sequences according to techniques described herein.

The server computing device determines (750) a customer service metric based on a duration of time calculated for each sequence of events. In some embodiments, for each journey sequence, server 115 calculates a duration of time from when its first event occurred until its last event occurred, and computes a LoE metric based on an average duration of time taken to complete a SKU based on the calculated durations of time for journey sequences comprising an anchor event for that SKU. In some embodiments, server 115 determines the anchor threshold based on an output of a machine learning model applied to the calculated durations of time for journey sequences comprising an anchor event for that SKU.

As discussed above, interactions with web channel 120f can provide reliable information about the intended service request user 105 is trying to initiate or carry out, assuming user 105 does not make any errant or spurious web clicks. For example, user 105 may mean to select a certain link (e.g., Change Address) as part of imitating or carrying out a service request, and instead click a nearby link (e.g., Change Beneficiary Information) by accident. Otherwise, user 105 may just use trial and error and try clicking several links when it is not clear which link will bring user 105 to the webpage with content best suited to help user 105 initiate or carry out the intended service request.

In some instances, errant or spurious web clicks can cause a break in a journey sequence. For example, two sub-sequences that would have been included in the same journey sequence by the filtering and merging logic may not be when there are intervening events between them resulting from errant or spurious web clicks. Accordingly, there is a need for a method to automatically learn key sequential patterns from users' historical web click behaviors before the occurrence time of their specific services. Such a method could be integrated into the filtering and merging logic described herein to account for situations noted above in connection with errant or spurious web clicks. Further, the resulting patterns could be utilized as input features for users' behavior prediction in commonly employed classifiers such as Logistic regression and Support Vector Machines.

Clickstream data is composed from sequences of users' web search and web link clicks. Each click is an item of the clickstream sequence. Such data often have dynamic structures where underlying temporal patterns of n-gram (2, 3, 4-word combinations, etc. In the case of web clicks these n-grams would be web page tags) web page names are embedded and can represent users' intents of their next possible activities (e.g., initiating a service request, working on an in-process service request, etc.).

Existing sequential pattern search approaches consider the problem of discovering sequential patterns by handling lower bound of interval time as constraints in between the facts adjacent to each other, and count the frequency of n-gram adjacent facts across the entire database. In these techniques, minimum frequency threshold is usually set to find the most salient facts' combinations in items' occurrence order. Some techniques have considered both the lower and the upper bound of interval time between successive items in the sequences to filter out meaningless patterns with too long of an item interval.

However, existing approaches turn to only extract sequential patterns from items adjacent to each other. That is, given an item I(t) at the current time t, these methods will only associate I(t+1) as possibly import patterns {I(t)->I(t+1)}, and will not directly combine {I(t)->I(t+n), (n>=2)} as valid sequential patterns. In the case of sequential data with noisy items, especially users' web click behaviors as noted above, it is very likely that a user may click some web pages from its previous visited page by mistake, and thus the data item corresponding to such web page transition may not necessarily represent the user's actual behavioral intent.

According the technology described herein, in addition to setting the lower and upper bounds of items' interval time for the search of candidate patterns, a sliding window concept is used to associate the items that are not positioned adjacent to each other in a sequence but within a constrained interval time. This method benefits from both the existing method by setting the interval time constraints as well as the frequency threshold and the proposed sliding window structure, and thus it can mine a finer depiction of items' timing relationship, especially for clickstream sequences with errant or spurious clicks.

The pseudo code below includes exemplary routines and functions illustrating the operations of the technology described herein for associating non-adjacent events:

| Mapper: | |
|---|---|
| Input: | A sequence of clickstream S, |
| | The session id of each item session_id(item), |
| | The execution time of each item time(item), |
| | Current Sp set, Snew = Ø, and |
| | The maximum click interval time threshold T, output file dir D in hdfs |
| Output: | A set of possible sequential patterns Sp, |

New sequence set Snew

Mapper:

| | |
|---|---|
| 1: | for each session Si in S do |

| | |
|---|---|
| 2: | for each item p0 in Si do |

| | |
|---|---|
| 3: | if p0 not in Sp then |

| | |
|---|---|
| 4: | go to Step 13 |

// create a sliding window by combining all possible items that occurred after p with p,
as candidate sequential patterns

| | |
|---|---|
| 5: | if time(p) − time(p0) < T then |

| | |
|---|---|
| 6: | map(Set{p0 −>p }, 1) |
| 7: | time(Set{p0 −> p}) = time(p) |

// create new sequences with the first item as the Set{p0 −> p}, and items after p in Si

| | |
|---|---|
| 8: | Snew ← Snew ∪ sequence(set{po −> p}, Si\p), where Si\p denotes the |
| | subsequence of Si with all items after p |
| 9: | for all items ps in sequence(set(po −> p}, Si\p)): session_id(ps) = 1 End for |

| | |
|---|---|
| 10: | End if |

| | |
|---|---|
| 11: | End for |

| | |
|---|---|
| 12: | End for |
| 13: | write Snew to hdfs in D |

| Reducer: | |
|---|---|
| Input: | (key, value) pairs with key as sequential pattern name Sp and values as 1 |
| | lower frequency bound Lf and upper frequency bound Uf |
| Output: | key sequential patterns k and their corresponding frequency v |

Reducer:

| | |
|---|---|
| 1: | k = Sp, |
| 2: | v = sum(value) |
| 3: | If v < Uf and v > Lf then |

| | |
|---|---|
| 4: | return((k,v)) |

| | |
|---|---|
| 5: | else |

| | |
|---|---|
| 6: | return(Ø) |

| | |
|---|---|
| 7. | end if |

| Main: | |
|---|---|
| Nested MapReduce by looping through n-gram of sequential patterns | |
| Input: | n-gram N, |
| | Sp= Ø |
| Output: | all n-gram key sequential patterns Sp |

Main:

| | |
|---|---|
| 1: | for each n-gram in [0,N] do |

| | |
|---|---|
| 2: | if n<2 then |

| | |
|---|---|
| 3: | for each Si in S do |

| | |
|---|---|
| 4: | for each p in Si do |

| | |
|---|---|
| 5: | map(p,1) |

| | |
|---|---|
| 6: | else |

| | |
|---|---|
| 5: | Mapper(S) |

| | |
|---|---|
| 6: | End if |
| 7: | Reducer((Sp,1)) |
| 8: | if k == Ø: break |
| 9: | else |

| | |
|---|---|
| 10: | Sp ← Sp ∪ k |
| 11: | S ← Snew |
| 12: | n = n+1 |

| | |
|---|---|
| 13: | End if |

| | |
|---|---|
| 14: | End for |

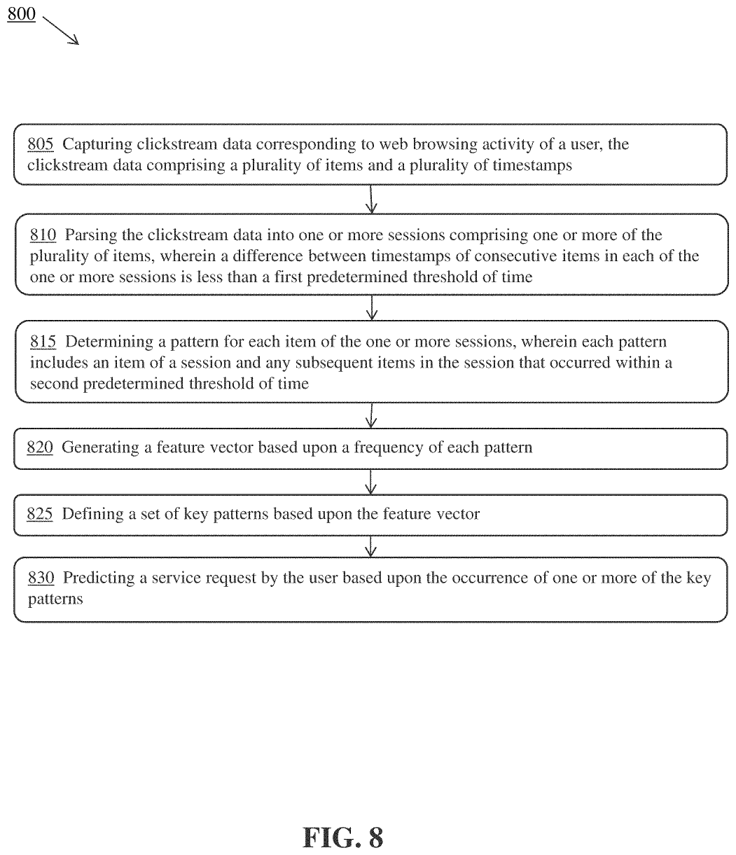

FIG. 8 is a flow diagram of a computerized method 800 for predicting a service request by a user based upon patterns of non-adjacent sequential items of clickstream data. Server 115 captures (805) clickstream data corresponding to web browsing activity of a user, the clickstream data comprising a plurality of items and a plurality of timestamps. For example, each of the timestamps can correspond to one of the plurality of items of clickstream data and indicate a time the web link represented by the corresponding item was clicked. As described above, web channel 120f captures data about the web activity of user 105.

Server 115 parses (810) the clickstream data into one or more sessions comprising one or more of the plurality of items, wherein a difference between timestamps of consecutive items in each of the one or more sessions is less than a first predetermined threshold of time. A similar mechanism as described above is used to analyze each item of web click data from web channel 120f, and assemble sessions based on the timestamps captured for each web click. Threshold values set the bounds of the time period that is analyzed.

Server 115 determines (815) a pattern for each item of the one or more sessions, wherein each pattern includes an item of a session and any subsequent items in the session that occurred within a second predetermined threshold of time. Sequences of web click events are assembled into sessions using logic similar to that described above. The sessions can be further analyzed to determine patterns of click stream data occurring within a certain threshold of time.

Server 115 generates (820) a feature vector based upon a frequency of each pattern. For example, server 115 can generate the feature vector based on the sum of each identified pattern's frequency across a number of sessions. In some embodiments, for generating the feature vector, server 115 generates a frequency matrix including a frequency value for each session that indicates a number of times each pattern occurred in the session, and then generates the feature vector based upon the frequency matrix. The resulting feature vector includes a value for each pattern that indicates a sum of the frequency values for each pattern for all of the one or more sessions.

Server 115 defines (825) a set of key patterns based upon the feature vector. In some embodiments, based on the feature vector, the server 115 determines patterns with frequency values within a predetermined frequency range, and appends the patterns with frequency values within a predetermined frequency range to the set of key patterns.

Server 115 predicts (830) a service request by the user based upon the occurrence of one or more of the key patterns. In some embodiments, server 115 captures service request data that includes a plurality of service requests and a plurality of service timestamps indicating a time each service was requested. Server 115 then correlates one or more of the key patterns with each service request based upon the proximity in time between the occurrences of the one or more key patterns with the service request. The resulting feature vector can be used as an input of a classification algorithm (e.g. Logit-Reg, SVM) for predicting the service request that user 105 is intending to initiate or work on.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

Variations, modifications, and other implementations of what is described herein will occur to those of ordinary skill in the art without departing from the spirit and the scope of the invention. Accordingly, the invention is not to be limited only to the preceding illustrative descriptions.

1. A method for determining a customer service metric using time-based predictive association based on user interactions over a plurality of interaction channels, the method comprising:
capturing, by a server computing device, a plurality of events associated with one or more intended transaction types;
identifying, by the server computing device, each event of the plurality of events as a characterized event or an uncharacterized event;
sorting, by the server computing device, the plurality of events in chronological order based on an attribute of each event indicating a time at which the event occurred;
creating, by the server computing device, a sequence of events comprising the earliest event of the plurality of events;
processing, by the server computing device, the plurality of events in chronological order, wherein each event of the plurality of events is analyzed against a chronologically consecutive event that occurred later in time, the processing step comprising:
(i) determining, by the server computing device, that:
the earlier event is an uncharacterized event that occurred within a first predetermined period of time before the later event, and the sequence does not comprise a characterized event; or
the earlier event is a characterized event or the sequence comprises a characterized event, and the earlier event occurred within a second predetermined period of time before the later event; and
(ii) appending, by the server computing device, the later event to the sequence of events; or
(iii) creating, by the server computing device, an additional sequence of events comprising the later event;
repeating, by the server computing device, the processing step for one or more additional sequences of events until each event of the plurality of events is included in one of the sequences of events;
filtering, by the server computing device, the sequence of events and any additional sequences of events; and
determining, by the server computing device, a customer service metric based on a duration of time calculated for each sequence of events.

2. The method of claim 1 wherein filtering the sequence of events and any additional sequences of events comprises:
discarding, by the server computing device, sequences of events that do not comprise a characterized event; and
determining, by the server computing device, the sequences of events comprise:
a characterized event indicative of the same intended transaction type, and
an event in a first sequence of events occurred within a third predetermined period of time of an event in a second sequence of events; and
merging, by the server computing device, sequences of events.

3. The method of claim 1 wherein filtering the sequence of events and any additional sequences of events comprises:
determining, by the server computing device, a sequence retention threshold based on a frequency of occurrence for each of a plurality of historical sequences;
discarding, by the server computing device, sequences of events matching one of the plurality of historical sequences whose frequency of occurrence is less than the sequence retention threshold; and
determining, by the server computing device, the sequences of events comprise:
a characterized event indicative of the same intended transaction type, and
an event in a first sequence of events occurred within a third predetermined period of time of an event in a second sequence of events
merging, by the server computing device, sequences of events.

4. The method of claim 1 wherein identifying each event of the plurality of events as a characterized event or an uncharacterized event comprises, for each event:
analyzing, by the server computing device, interaction channel data corresponding to a interaction channel utilized during an event;
tagging, by the server computing device, the event as a characterized event if an intended transaction type can be determined based on interaction channel data associated with the event; and
tagging, by the server computing device, the event as an uncharacterized event if an intended transaction type cannot be determined based on interaction channel data associated with the event.

5. The method of claim 4 wherein the interaction channel data comprises one or more of tokens extracted from at least one URL clicked by the user, keywords entered in an internet search by the user, notes generated by a call center operator based on a call with the user, a transcript of an online chat session between a customer service agent and the user, and notes generated by a customer service representative based on a branch visit by the user.

6. The method of claim 5 wherein the interaction channel utilized during an event comprises one of a phone, an email, a postal mailing, a fax, an online chat, a webpage, and a branch visit.

7. The method of claim 1 wherein the second predetermined period of time is longer in duration that the first predetermined period of time.

8. The method of claim 1 wherein the third predetermined period of time is longer in duration that the second predetermined period of time.

9. The method of claim 1 wherein each of the plurality of events is associated with a customer based on event data.

10. The method of claim 9 wherein event data comprises one or more of a customer identification number, a customer account number, customer credential information, and a customer social security number.

11. The method of claim 1 wherein determining a customer service metric further comprises:
calculating, for each sequence of events, a duration of time from when its first event occurred until its last event occurred;
computing an average duration of time to complete an intended transaction type based on the calculated durations of time for sequences of events comprising a characterized event indicative of the intended transaction type.

12. The method of claim 1 wherein the server computing device comprises at least one of: a cluster of server computing devices, a server computing device employing massively parallel computing algorithms, and a server computing device employing a plurality of processors.

13. The method of claim 1 further comprising determining the second predetermined period of time based on an output of a machine learning model applied to a plurality of historical sequences.

14. The method of claim 11 further comprising determining the second predetermined period of time based on an output of a machine learning model applied to the calculated durations of time.

15. A computerized method for predicting a service request by a user based upon patterns of non-adjacent sequential items of clickstream data, the method comprising:
capturing, by a server computing device, clickstream data from a plurality of channels, wherein the clickstream data corresponds to web browsing activity of a user and comprises a plurality of items and a plurality of timestamps;
storing, by the server computing device, the captured clickstream data in a segment of data in a database, wherein the segment of data corresponds to the web browsing activity of the user;
parsing, by the server computing device, the segment of data into one or more sessions comprising one or more of the plurality of items, wherein a difference between timestamps of consecutive items in each of the one or more sessions is less than a first predetermined threshold of time;
determining, by the server computing device, a pattern for each item of the one or more sessions, wherein each pattern includes an item of a session and any subsequent items in the session that occurred within a second predetermined threshold of time;
generating, by the server computing device, a feature vector based upon a frequency of each pattern;
defining, by the server computing device, a set of key patterns based upon the feature vector;
predicting, by the server computing device, a service request by the user based upon the occurrence of one or more of the key patterns; and
storing, by the server computing device, the predicted service request in the segment of data in the database.

16. The computerized method of claim 15 wherein generating the feature vector further comprises:
generating, by the server computing device, a frequency matrix comprising for each session a frequency value indicating a number of times each pattern occurred in the session; and
generating, by the server computing device, the feature vector based upon the frequency matrix, the feature vector comprising for each pattern a value indicating a sum of the frequency values for each pattern for all of the one or more sessions.

17. The computerized method of claim 16 wherein defining the set of key patterns further comprises:
determining, by the server computing device, based on the feature vector, patterns with frequency values within a predetermined frequency range; and
appending, by the server computing device, the patterns with frequency values within a predetermined frequency range to the set of key patterns.

18. The computerized method of claim 15 wherein each of the plurality of items represents a web link clicked by the user.

19. The computerized method of claim 18 wherein each of the plurality of timestamps corresponds to one of the plurality of items and indicates a time the web link represented by the corresponding item was clicked.

20. The computerized method of claim 15 wherein the first predetermined threshold of time is smaller than the second predetermined threshold of time.

21. The computerized method of claim 15 wherein the first predetermined threshold of time is larger than the second predetermined threshold of time.

22. The computerized method of claim 15 wherein predicting the service request by the user further comprises:
capturing, by the server computing device, service request data comprising a plurality of service requests and a plurality of service timestamps indicating a time each service was requested; and
correlating, by the server computing device, one or more of the key patterns with each service request based upon the proximity in time between the occurrence of the one or more key patterns with the service request.

23. The computerized method of claim 22 wherein the proximity in time between the occurrence of the one or more key patterns with the service request is about a minute.

24. The computerized method of claim 15 wherein the server computing device comprises a parallelized cluster of computing nodes.

25. The method of claim 15 wherein the server computing device comprises at least one of: a cluster of server computing devices, a server computing device employing massively parallel computing algorithms, and a server computing device employing a plurality of processors.

26. The method of claim 15 further comprising determining the second predetermined threshold of time based on an output of a machine learning model applied to a plurality of historical items and a plurality of historical timestamps.
